(19) United States
(12) Patent Application Publication
(10) Pub. No.: US 2009/0020654 A1
(43) Pub. Date: Jan. 22, 2009

(54) Harness with mounted engine frame

(76) Inventor: Nelson Tyler, Van Nuys, CA (US)

Correspondence Address: Colin P. Abrahams, Suite 400, 5850 Canoga Avenue, Woodland Hills, CA, 91367, US

(21) Appl. No.: 12/157,024

(22) Filed: Jun. 6, 2008

Related U.S. Application Data
(60) Provisional application No. 60/933,945, filed on Jun. 8, 2007.

(51) Int. Cl. B64C 29/00

(52) U.S. Cl. 244/23 A

(57) ABSTRACT

A harness with mounted engine frame comprises a harness to be worn by a user. An engine support arm is mounted on the harness and a pair of lateral arms extend from the engine support arm. At least one engine is associated with each lateral arm. A connector attaches directly or indirectly to the harness for receiving the engine support arm, so that the engine support arm is movable relative to the harness in response to engine output and other flight conditions.

### CROSS REFERENCE TO RELATED APPLICATIONS

This application claims the benefit of U.S. Provisional Patent Application No. 60/933,945 filed Jun. 8, 2007, which is incorporated herein by reference in its entirety.

### FIELD AND BACKGROUND OF THE INVENTION

The present invention relates to a personal, strap-on flying device, or a harness with a mounted engine frame which can be used for personal flight.

The existing technology in this area typically comprises one gas turbine engine immovably mounted vertically, inlet down, to a harness belt worn by a pilot. This type of design has several drawbacks, some of which are set below.

(1) All necessary thrust for flight is needed from one engine. Therefore, the engine must be large in diameter and is consequently also heavy on the harness.

(2) The engine must be complex in design since the interior main shaft must be split, or in two sections, so the spinning mass can be counter rotating and equally balanced between the two sections. This is necessary to cancel out the gyro precession effect that one shaft would create. The gyro effect of this size engine would make controlled flight very difficult on such a small flying machine.

(3) With the engine mounted vertically, inlet down, the exhaust thrust gas must travel upward, be split and diverted left and right a sufficient distance to clear the pilot and then turn downward to create the upward thrust required for flight. A long exhaust is the result of such a configuration and this causes a loss of thrust.

(4) When the engine is immovably mounted to the harness, it is then necessary to have the gas exit nozzles separate from the exhaust ducts and moveable fore and aft and left and right so as to effectively be able to control the direction of flight. This arrangement adds complexity, weight as well as the additional loss of thrust because of the additional divergence of the exhaust gases.

(5) When the engine inlet is low and faces down, it is more likely that the engine will reingest hot gas while hovering close to the ground or approaching the ground. This hot gas ingestion may cause a loss of engine power, and at a critical time of flight as well.

### SUMMARY OF THE INVENTION

According to one aspect of the present invention, there is provided a harness with mounted engine frame comprising a harness to be worn by a user, a pair of lateral arms, at least one engine in each lateral arm, an engine support arm for supporting the lateral arms, and a connector attached directly or indirectly to the harness for receiving the engine support arm, the engine support arm being movable relative to the connector in response to engine output and other flight conditions.

Preferably, each lateral arm has a plurality of engines, preferably four engines arranged substantially in each arm. Preferably, the engines on one arm are counter-rotating to the engines on the other arm. Alternatively, engines on one arm counter rotate with respect to engines on the same arm. In effect, it is desirable that rotating and counter-rotating forces are substantially equal so that opposing rotational forces are to a large degree canceled out with respect to each other.

The connection between the engine support arm and the connector may take many different forms. In one embodiment, the connector may be a rail on the back of the harness and the connector a bracket which engages the rail.

The engine support arm is preferably able to move from side to side as well as in an arc, i.e. in a circular movement about the connector. The side to side or lateral type movement is preferably used to compensate for variations in engine thrust based on different outputs of the various engines, and also for engine failure. Thus, if the engine thrust output on one side of the harness (that is, on one lateral arm) is significantly different to that on the other, the engine support arm will move relative to the connector so as to move a lateral arm toward or away from the harness to compensate for this variation in engine thrust or failure of an engine.

Preferably, the engines are vertically mounted jet lift engine sets, and there are preferably an even number of engines in total and a the same number of engines on each side in a specific lateral arm. Preferably, too, all engines are mounted so as to be gimbaled in unison in three axes.

In order to control the flight direction and other flight parameters, control handles are preferably formed on each lateral arm or the engine support arm which may extend forwardly through the lateral arm. The control handles would allow the operator to move a bank of engines on a lateral arm inwardly or outwardly to compensate for engine thrust variations.

Vertical control may be obtained by twisting, for example, the right hand control grip which causes the engines to increase or decrease thrust output. The control grip connection to the engines can be by push/pull cable or electronic wire connections or other suitable mechanisms in well known fashion.

Using multiple engines preferably allows a much smaller outer diameter of each engine which allows a lower overall profile as well as better fore/aft balance.

By the positioning of multiple engines, even in number, with inlets downwards, there is created zero or at least reduced overall gyro precession effect.

All Peripheral components such as fuel tank, filters, pumps and batteries are preferably affixed directly to the pilot harness belt and connected to the engine package via flexible hose and wire or other suitable means. This may tend to keep the weight of the engine package lower, which may also allow quicker control movement by the pilot.

To facilitate change out of the harness belt for different size pilots, all peripheral components as well as the engine package spherical rod end bolt receiver collar are preferably attached to a center line bent tube frame spine. This spine may preferably be attached to the harness belt via four quick release pins, or such other suitable mechanisms.

Preferably, the belt portion of the harness which goes around the waist of the user or pilot is hinged and adjustable to allow for the comfort of differently sized pilots.

Preferably, the lateral arm supporting the engines is pivotable and lockable in the operational and stored position respectively.

In one embodiment, the connector includes a bracket, and the bracket comprises at least one wheel which moves in a recess of the rail, a body portion, an end portion which pivotally connects to the engine support arm and an end connector for pivotally connecting the end portion to the engine support arm. Preferably, the rail has stops at or near the ends thereof to prevent the bracket from moving out of the recess of the rail.

In one form, the connector comprises a clamp connected to the harness, a support rod having one end thereof extending from the clamp and opposing end thereof with a rod end, the rod end being connectable to the engine support arm.

In another embodiment, the connector comprises a pair of parallel substantially horizontal rods mounted on the harness, a bearing block mounted on the rods for movement therealong, a fastening mechanism on the bearing block for connection to the engine support arm, and slide bearings to facilitate movement of the bearing block along the rods.

Preferably, the box beam comprises a hollow rectangular box and engine mounts within the rectangular box for receiving and holding the engines.

According to another aspect of the invention, there is provided a harness with mounted engine frame comprising: a harness; an engine support arm mounted on the harness; lateral supports extending from the engine support arm; at least one engine associated with each lateral support; and a connector mechanism between the harness and the engine support arm to permit movement of the engine support arm relative to the harness in response to engine output and other flight conditions.

### BRIEF DESCRIPTION OF THE DRAWINGS

In the drawings:

FIG. 1 is a front perspective view of a harness with mounted engine frame in accordance with one aspect of the invention;

FIG. 2 is a side view of the harness with mounted engine frame as shown in FIG. 1 shown mounted on a user;

FIG. 3 is a front view of the harness with mounted engine frame as shown in FIG. 1 shown mounted on a user;

FIG. 4 is a back view of the harness with mounted engine frame as shown in FIG. 1 shown mounted on a user;

FIG. 5 is a side view in section of the harness with mounted engine frame as shown in FIG. 1 of the drawings;

FIG. 6 is detail of the back view of the harness with mounted engine in accordance with one aspect of the invention showing the rail mechanism for facilitating lateral movement of engine support arm;

FIGS. 7(a) and 7(b) are side and back views respectively of another embodiment of the invention for allowing side to side movement of the engine arm and related components;

FIGS. 8(a) and 8(b) are side and back views respectively of yet another embodiment of the invention for allowing side to side movement of the engine arm and related components;

FIG. 9 is a detail of the harness with mounted engine of the invention showing mounting of the engine on or in the engine support of the invention; and

FIGS. 10(a) and 10(b) show side and top views respectively of the harness with mounted engine of the invention showing another form of mounting of the engine on or in the engine support of the invention.

### DETAILED DESCRIPTION OF THE INVENTION

Reference is now made to the drawings which are described and explained below.

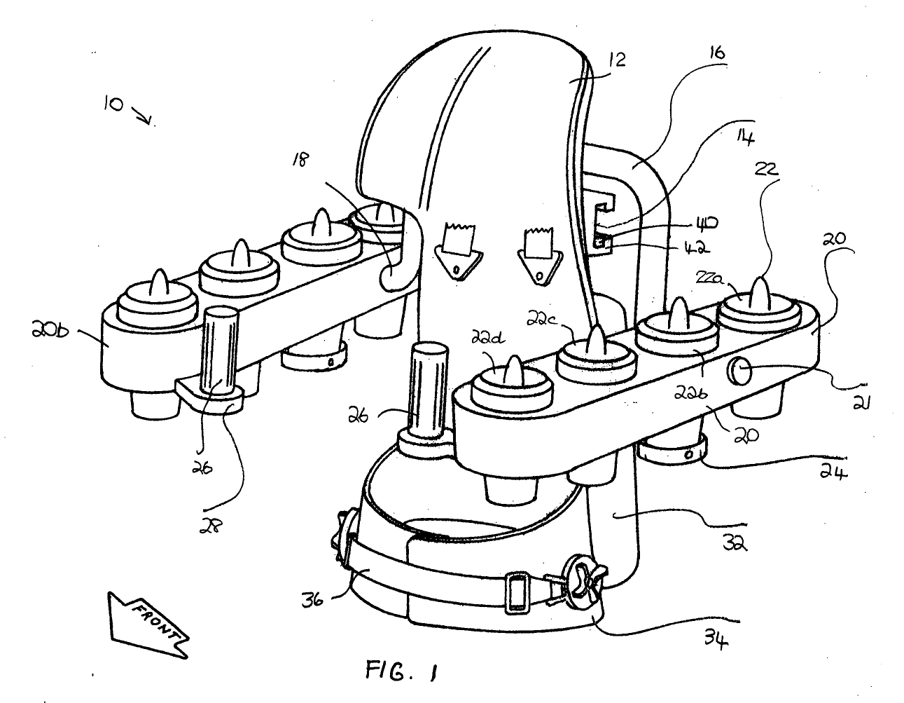

FIG. 1 of the drawings is a front perspective view of a harness 10 with mounted engine frame in accordance with one aspect of the invention. The back 12 of the harness has a support rail 14 upon which is movably mounted an engine support arm 16 which extends around to each side of the harness 10 to pivotally hold the engine box beam support 18. The engine box beam support 18 has a fold up pivot tube 20 by means of which the engine box beam support 18 can be raised and lowered and locked in desired positions.

The engine box beam support 18 supports a box beam 20 and each box beam 20 supports four engines 22 in the embodiment shown, all vertically mounted in a linear configuration and discharging downwardly to provide the thrust for flight. One engine includes a yaw ring 24.

A control handle 26 is mounted on a control handle support arm 28 which may be mounted on the box beam 20 or on the engine box beam support 18 which extends through the box beam 20 to provide the necessary strength and support,

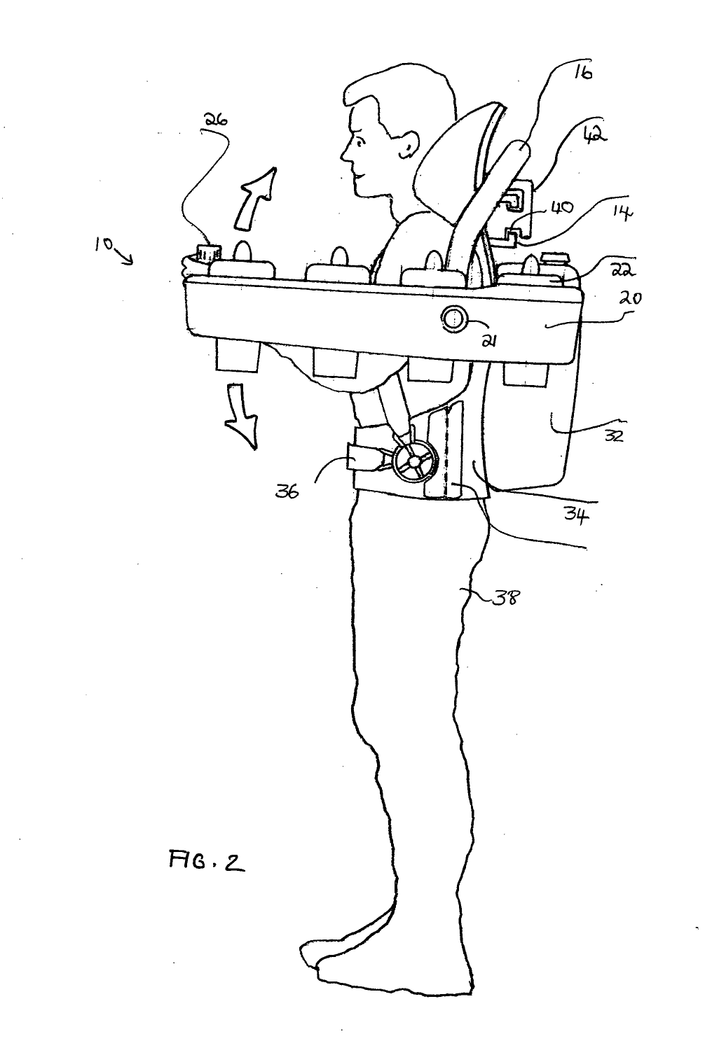

A fuel tank 32 (see FIG. 2) is mounted on the back of the harness 10. Further, the harness 10 includes a belt 34 and pivoting waist band 36 fastened by the belt 34, a construction which provides comfort and flexibility to the pilot 38 so that adjustments and tightening can be made based on pilot size and body type.

In FIG. 1, it will be seen that there are four engines 22a, 22b, 22c and 22d in each box beam 20. The engines 22 are preferably constituted by both rotating and counter rotating properties. Preferably, there will be an even number of engines 22 and there will be an equal number of rotating and counter rotating engines 22 to balance the device. All engines 22 on one box beam 20a may rotate in one direction and all the engines on the other box beam 20b may rotate in the other direction.

However, this is just one of many options. Engines 22 on one box beam 20 may be both rotational an counter rotational. Further, the engines 22 may be of different power and thrust and not all of the same power and thrust. It is desirable, however, that whatever the selection of engine types and positions thereof, the sum of engine force rotating in one direction preferably is substantially equal to the sum of engines force rotating in the other or counter direction.

FIG. 2 of the drawings shows a side view of a harness 10 with a mounted support arm 16 as generally represented in FIG. 1 of the drawings. In this figure, a pilot 38 is shown wearing the harness 10 and frame. This figure also shows in further detail one aspect of the connection between support arm 16 and the support rail 14. The support rail 14 has a slot 40 or recess which receives a lift bracket 42 attached to the engine support arm 16.

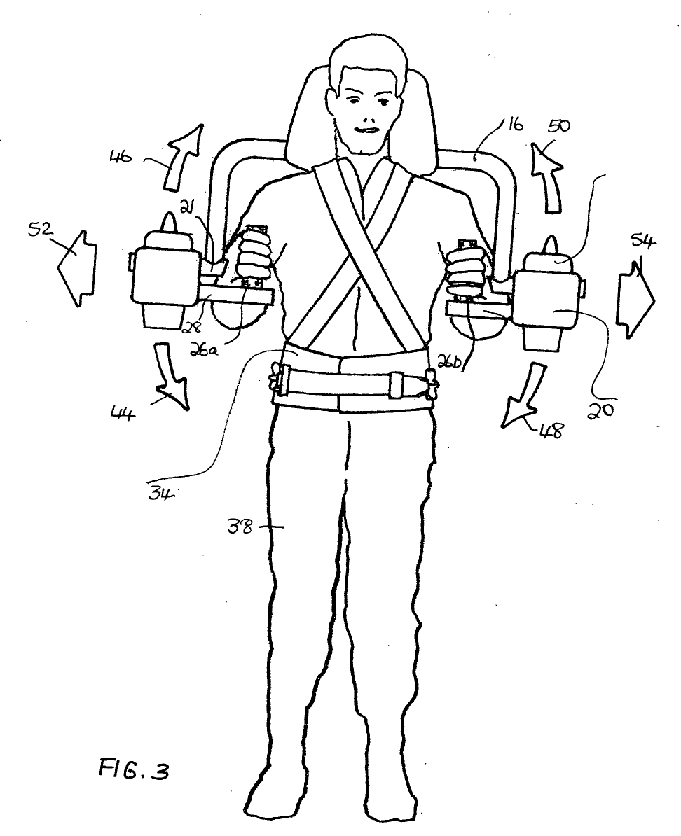

FIG. 3 of the drawings shows a front view of the harness 10 with mounted engine frame shown in FIG. 2, with a strapped in pilot 38. The pilot 38 can be seen holding the control handles 26a and 26b. Particularly, reference is made to the arrows 44, 46, 48, 50, 52 and 54 showing possible movement which the engine support arm 16 can make. First, there is left and right lateral type movement as indicated by opposing arrows 52 and 54. Second, there is the arcuate or circular type movement which the engine support arm can make indicated by the four arrows 44, 46, 48 and 50, two up and two down, representing this movement. The lateral arrows 52 and 54 allow for the engine support arm 16 to move a bank of engines 22 on one side of the pilot 38 either away from the pilot 38 or toward the pilot 38. At the same time, the oppositely bank of engines 22 will move either toward or away from the pilot respectively. As mentioned above, this movement may compensate for variations in the thrust of engines 22 or even engine failure, to keep the harness 10 and pilot 38 stable by moving the engines 22 relative to the pilot 38 and therefore adjusting flight parameters to stabilize the device.

The movement represented by the up and down arrows 44, 46, 48 and 50 may be made by the pilot 38 to control direction and movement.

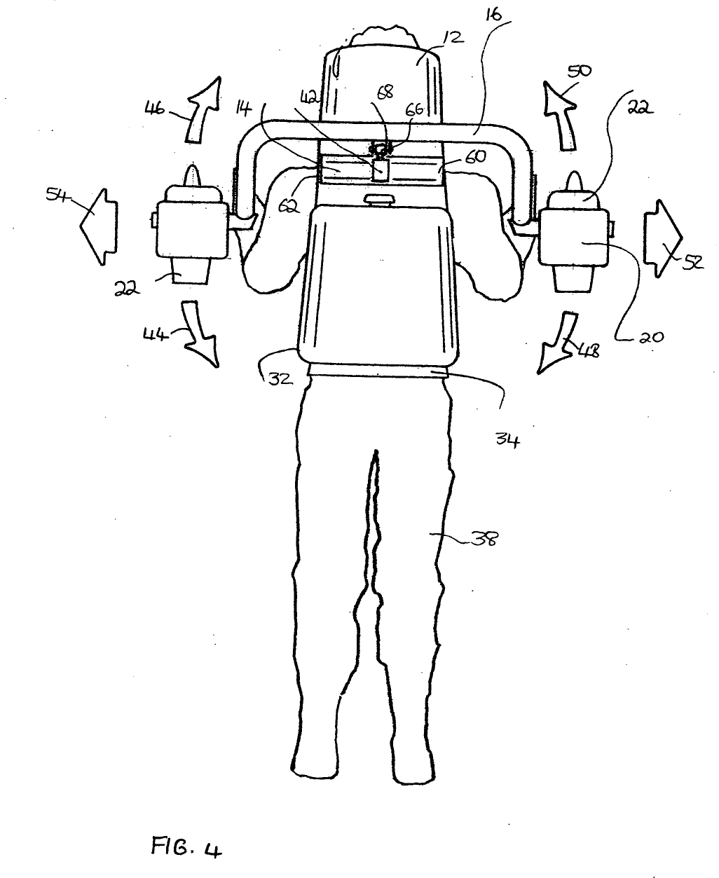

FIG. 4 of the drawings shows a back view of a harness 10 with mounted engine support arm 16 as shown generally in the preceding drawings. Of particularly note in this FIG. 4 is the form of connection between the engine support arm 16 and the support rail 14. The support rail 14 has riding therein a lift bracket 42 which can slide laterally to the left and right respectively of the support rail 14. Appropriate end stops 60 and 62 will be positioned to ensure that the lift bracket 42 is securely maintained within and does not slide out of the support rail 14.

The engine support arm 16 has depending therefrom in a substantially central location a rod connector 66 and this engages with a rod end 68 of a generally ball shape. It will be appreciated that one advantage of such a rod connector 66 and rod end 68 construction is that the pilot 38 can always hang substantially vertically regardless of the position, tilt, or movement of the rail 14 and support engine arm 16 respectively. The compensating and directional movement of the support rail 14 and engine support arm 16 in normal flight operation together will not therefore tend to move the pilot 38 into an unnatural feeling off-vertical position, since the rod end 68 will move in the rod connector 66 to compensate for this.

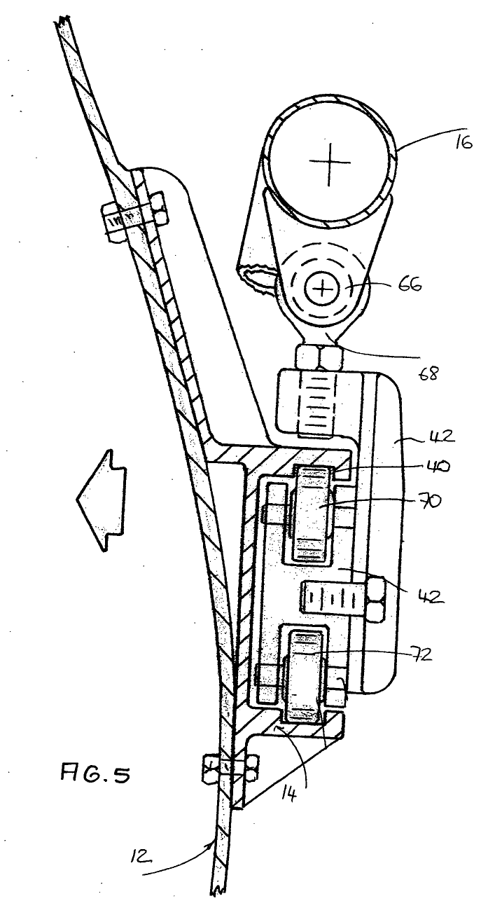

FIG. 5 is section side view through a harness 10 with mounted engine frame 16 generally as illustrated in the preceding drawings. In this FIG. 5, it will be noted that the lift bracket 42 has a pair of wheels 70 and 72, upper 70 and lower 72 respectively, which slide in the recess 40. This construction allows for the quick and appropriate response of the engine support arm 16 and its ability to move laterally as result of flight engine changes which require compensation.

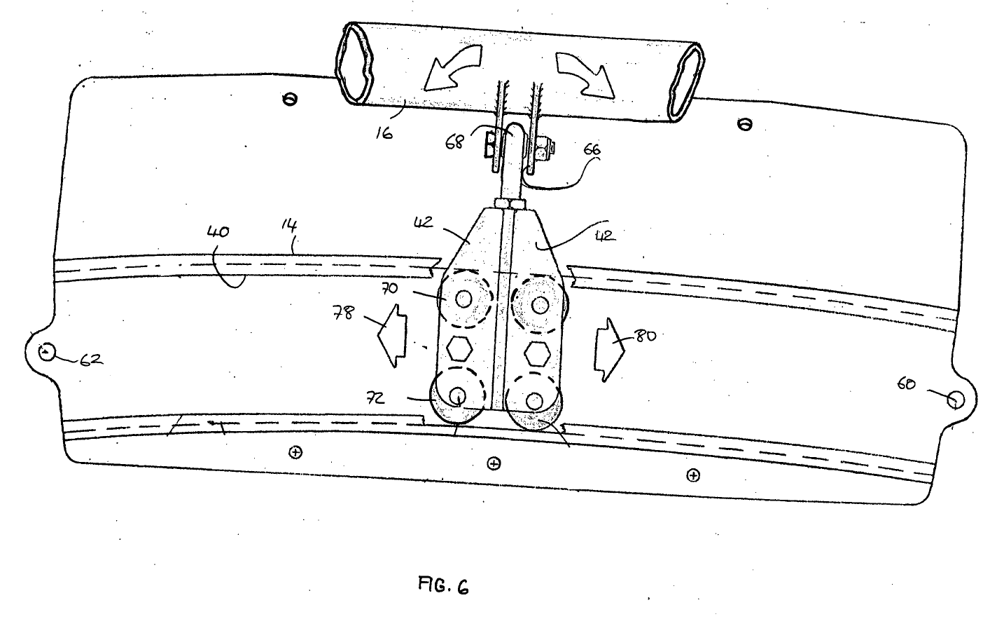

FIG. 6 of the drawings shows a detail of the lift bracket 42 riding in the support rail 14. In this rear view, it will be seen that the support rail 14 is slightly curved, with a slightly higher central area and lower side areas edges. The stops 60 and 62 at each end of the rail 14 can also be seen. The normal operating position of the lift bracket 42 is of course substantially central, but it has the ability to move left or right, as shown by arrows 78 and 80 in FIG. 6, in the support rail 14 in response to engine 22 changes and failures as mentioned above.

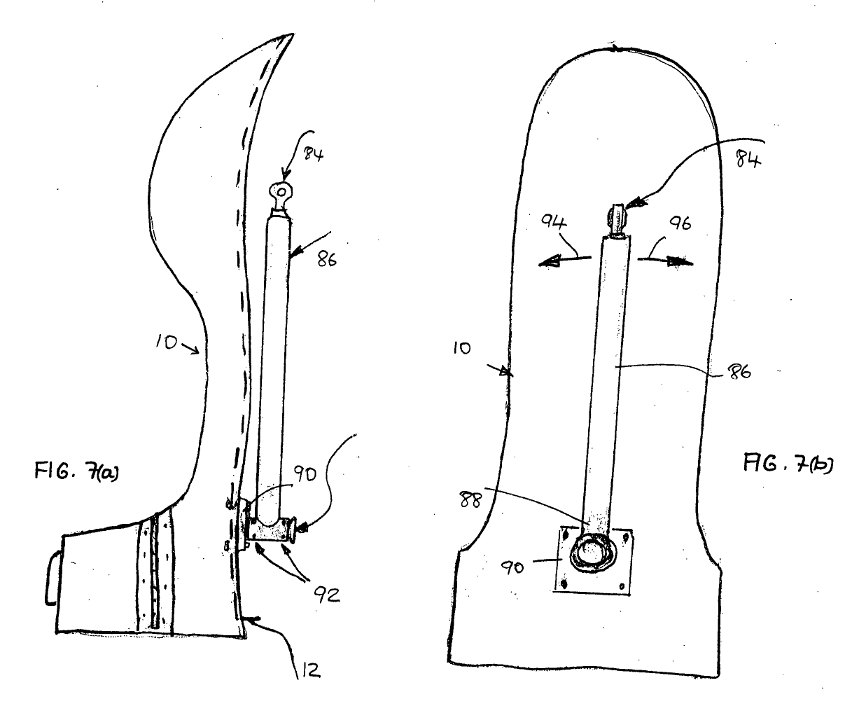

FIGS. 7(a) and 7(b) of the drawings show a side view and a rear view respectively of alterative embodiments for mounting the engine support to the harness 10. In this illustrated embodiment, the engine support arm (not shown in this figure) connects to one end 84, or the rod end 84, of a support rod 86 which is in turn connected at its other end 88 to a bracket or a clamp 90, through suitable bearings 92, which is in turn fastened to the harness 10. The support rod 86 is capable of left and right movement, as shown by arrows 94 and 96 in FIG. 7(b), by appropriate pivotal action about the bearings 92 in the bracket 90.

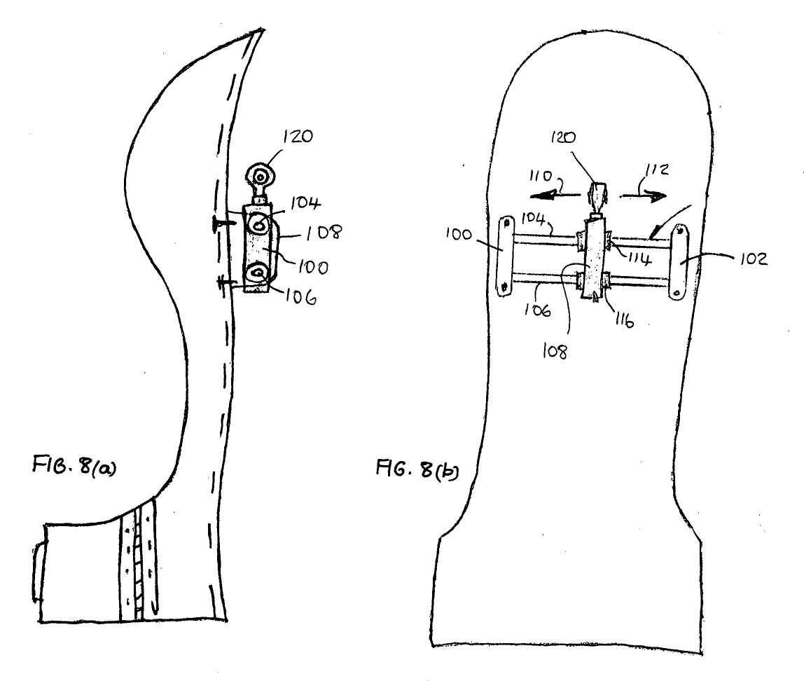

FIGS. 8(a) and 8(b) show side and rear views respectively of yet another alterative embodiments for mounting the engine support 16 to the harness 10. In this embodiment, a pair of laterally positioned rod clamp blocks 100 and 102 are fastened at ends of the harness 10 and support therebetween a pair of substantially parallel fixed rods 104 and 106. A bearing block 108 rides the fixed rods 104 and 106 and moves either to the left or right, as shown by arrows 110 and 112 in FIG. 8(b), based on flight parameters and compensations needed, as already discussed above. The bearing block 108 includes slide bearings 114 and 116 to facilitate easy and responsive movement of the bearing block 108 along the fixed rods 104 and 106. Further, the bearing block 108 has at its upper end a fastening mechanism 120 which allows necessary attachment thereof to the engine support arm 16, as already described in other embodiments.

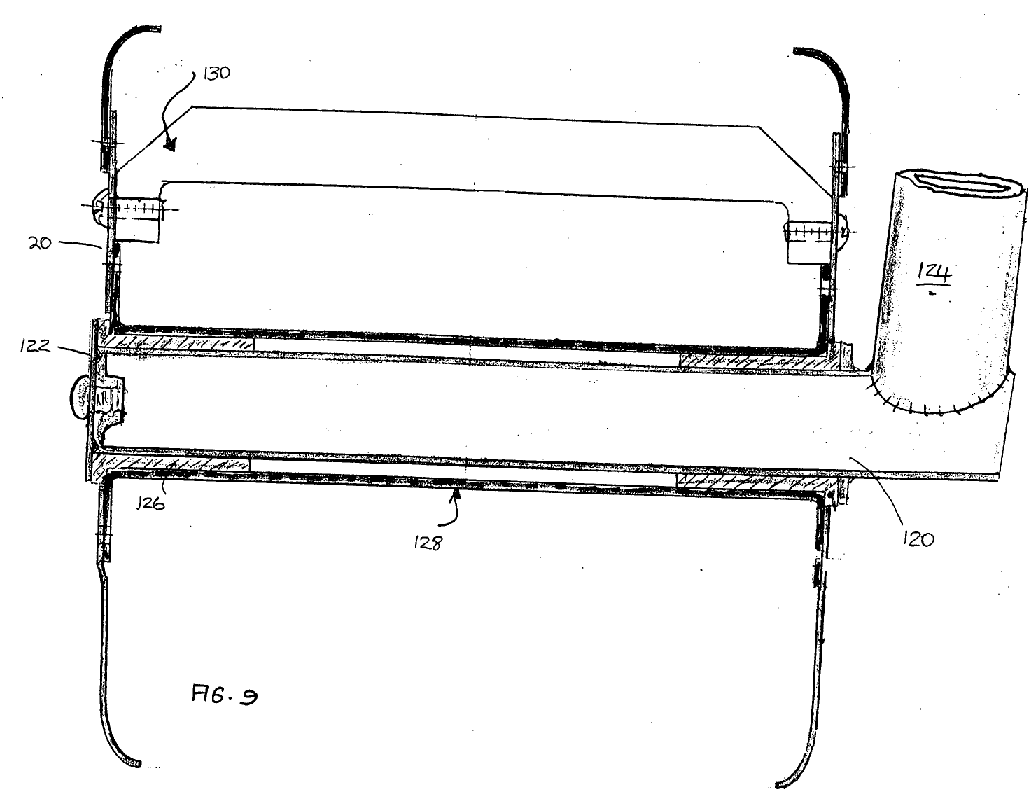

FIG. 9 of the drawings is a detail view through the engine support box beam 20 and shows a engine support arm 120 therein and its pivotable characteristics. The support arm 120 comprises a fold-up pivot tube 122 attached to an engine arm 124. The pivot tube 122 has bearings 126 between its outer surface and the box beam 20. The box beam 20 has a tube support collar 128. The engine box beam 20 may be made of any suitable material, one preferred embodiment having a fiberglass construction. The necessary construction and mounts for the engine which slides in from above are shown in this figure. The engines 22 are solidly and securely fixed and supported in the box beam by engine mounts 130. While securely holding the engines 22 in the box beam 20 and keeping them in the correct position and orientation, the engines may be removed for maintenance or replacement.

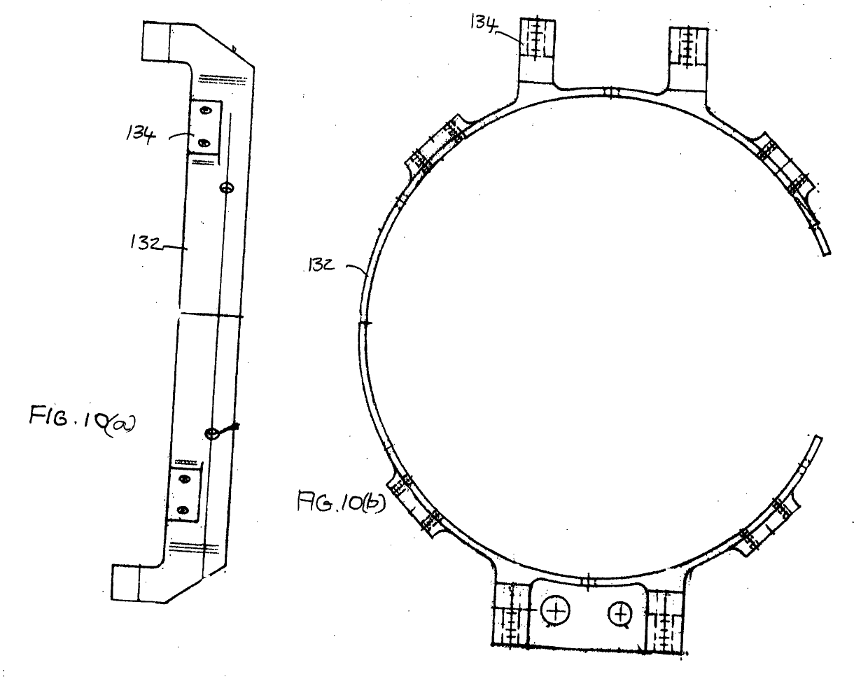

FIGS. 10(a) and 10(b) show characteristics of the engine mount 130 in side (FIG. 10(a)) and top (FIG. 10(b)) view, illustrating details thereof in accordance with just one of many embodiments of the invention. Any suitable mechanism for securing the engines in position may be used. The engine mount 130 in this embodiment has a circular receiving ring 132 with mounting tabs 134 fro securement to the box beam 20. The receiving ring 132 is sized and dimensioned so as to securely receive an engine 20 on the one hand, and also itself be securely fastened to the box beam 20 and/or pivot tube 122 or such other structure so as to give it the necessary strength.

The invention is not limited to the details described herein. For example, any suitable mechanical arrangement for securing the engine support to the harness may be used which give effect to the ability to move in a lateral direction to compensate for flight changes and enhance safety and comfort of the pilot.

Further, any number oft engines of the same or different types may be used but it is preferred that the collective effect of the engines, comprised of rotational and counter-rotational engines, be substantially balanced.

1. A harness with mounted engine frame comprising:
a harness to be worn by a user;
an engine support arm mounted on the harness;
a pair of lateral arms extending from the engine support arm;
at least one engine associated with each lateral arm; and
a connector attached directly or indirectly to the harness for receiving the engine support arm, so that the engine support arm is movable relative to the harness in response to engine output and other flight conditions.

2. A harness with mounted engine frame as claimed in claim 1 wherein each of the lateral arms includes a box beam for supporting the engine.

3. A harness with mounted engine frame as claimed in claim 1 wherein each lateral arm has a plurality of engines.

4. A harness with mounted engine frame as claimed in claim 2 wherein there are four engines arranged substantially in each arm.

5. A harness with mounted engine frame as claimed in claim 4 wherein the engines on one arm are counter-rotating to the engines on the other arm.

6. A harness with mounted engine frame as claimed in claim 4 wherein engines on one arm counter rotate with respect to engines on the same arm so that opposing rotational forces are substantially canceled out with respect to each other.

7. A harness with mounted engine frame as claimed in claim 1 wherein the connector comprises a rail on a back portion of the harness and a bracket which engages with and moves with respect to the rail.

8. A harness with mounted engine frame as claimed in claim 1 wherein the connector allows the engine support arm to move from side to side as well as in an arc relative to the harness.

9. A harness with mounted engine frame as claimed in claim 1 wherein the engines are vertically mounted jet lift engine sets, and there are an even number of engines in total and the same number of engines in each of the lateral arms.

10. A harness with mounted engine frame as claimed in claim 9 wherein all engines are mounted on the lateral arms so as to be gimbaled in unison in three axes.

11. A harness with mounted engine frame as claimed in claim 1 further comprising control handles formed on each lateral arm for allowing the operator to move engines on a lateral arm inwardly or outwardly to compensate for engine thrust variations.

12. A harness with mounted engine frame as claimed in claim 11 wherein vertical control is achieved by twisting one of control handles causing the engines to increase or decrease thrust output.

13. A harness with mounted engine frame as claimed in claim 11 wherein the control handles operate by push/pull cable or electronic wire connections.

14. A harness with mounted engine frame as claimed in claim 1 wherein relative small multiple engines are used to allow for a smaller outer diameter of each engine which allows for a lower overall profile and better fore/aft balance.

15. A harness with mounted engine frame as claimed in claim 1 further comprising peripheral components including fuel tank, filters, pumps and batteries which are affixed directly to the pilot harness belt and connected to the engines via flexible hose and wire.

16. A harness with mounted engine frame as claimed in claim 15 wherein at least some peripheral components are attached to a center line bent tube frame spine attached to the harness belt via quick release pins.

17. A harness with mounted engine frame as claimed in claim 1 wherein the harness has a belt portion, the belt portion of the harness goes around the waist of the pilot and is hinged and adjustable to allow for the comfort of differently sized pilots.

18. A harness with mounted engine frame as claimed in claim 1 wherein the lateral arm supporting the engines is pivotable and lockable in the operational and stored position respectively.

19. A harness with mounted engine frame as claimed in claim 7 wherein the bracket comprises at least one wheel which moves in a recess of the rail, a body portion, an end portion which pivotally connects to the engine support arm and an end connector for pivotally connecting the end portion to the engine support arm.

20. A harness with mounted engine frame as claimed in claim 19 wherein the rail has stops at or near the ends thereof to prevent the bracket from moving out of the recess of the rail.

21. A harness with mounted engine frame as claimed in claim 1 wherein the connector comprises a clamp connected to the harness, a support rod having one end thereof extending from the clamp and opposing end thereof with a rod end, the rod end being connectable to the engine support arm.

22. A harness with mounted engine frame as claimed in claim 1 wherein the connector comprises a pair of parallel substantially horizontal rods mounted on the harness, a bearing block mounted on the rods for movement therealong, a fastening mechanism on the bearing block for connection to the engine support arm, and slide bearings to facilitate movement of the bearing block along the rods.

23. A harness with mounted engine frame as claimed in claim 2 wherein the box beam comprises a hollow rectangular box and engine mounts within the rectangular box for receiving and holding the engines.

24. A harness with mounted engine frame comprising:
a harness;
an engine support arm mounted on the harness;
lateral supports extending from the engine support arm;
at least one engine associated with each lateral support; and
a connector mechanism between the harness and the engine support arm to permit movement of the engine support arm relative to the harness in response to engine output and other flight conditions.
